(19) United States
(12) Patent Application Publication
(10) Pub. No.: US 2006/0018802 A1
(43) Pub. Date: Jan. 26, 2006

(54) Method and apparatus for reconfiguring a labware storage system

(76) Inventors: Roger Bryan Greenway JR., Franklin, TN (US); Jon Arthur Jackson, Fairview, TN (US); John Randall Vinson, Franklin, TN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/182,056

(22) Filed: Jul. 15, 2005

Related U.S. Application Data
(63) Continuation-in-part of application No. 10/887,355, filed on Jul. 9, 2004.
(60) Provisional application No. 60/588,342, filed on Jul. 16, 2004.

(51) Int. Cl. B01L 9/00

(52) U.S. Cl. 422/104

(57) ABSTRACT

A system for storing labware. The system includes a frame that has a plurality of storage structures such as storage hotels included therein. Each of the storage structures may be configured to store one or more types of labware and may be configured to store different distributions of the types of labware. Each storage structure is also removable from the frame, thereby allowing for reconfiguration of the labware storage system. Also, a method of configuring a labware storage system.

### CROSS-REFERENCE TO RELATED APPLICATIONS

The present application claims priority to Provisional U.S. Patent Application entitled, “Method and Apparatus for Reconfiguring a Labware Storage System,” filed Jul. 16, 2004 and having been assigned Ser. No. 60/588,342. The disclosure of the above-cited Provisional Patent Application is hereby incorporated herein by reference in its entirety. The present application also claims priority to and is a continuation-in-part of U.S. patent application entitled “Microplate Storage Hotel Design,”filed Jul. 9, 2004, now pending, and having been assigned Ser. No. 10/887,355, the disclosure of which is hereby also hereby incorporated herein by reference in it entirety.

### FIELD OF THE INVENTION

The present invention relates generally to labware storage systems. The present invention also relates generally to methods of configuring labware storage systems.

### BACKGROUND OF THE INVENTION

In laboratories where experimental procedures require that multitudes of samples be collected and stored, labware storage systems are commonly utilized. Currently-available labware storage systems are configured to store pre-set quantities of one or more types of labware. For example, a currently-available labware storage system may allow for the storage of 5,000 microplates, each containing one hundred 1 ml experimental samples.

Because of the pre-set nature of currently-available labware storage systems, a system configured to store the above-mentioned 5,000 microplates could not be re-configured to store 2,000 microplates and 1,000 vials or even 50 bottles. Rather, an entirely new labware storage system would be needed, and significant costs would be incurred.

At least in view of the above, it would be desirable for novel labware storage systems and methods of configuring labware storage systems to be developed. These novel systems and methods would preferably allow for a fluctuating ratio of different types of labware to be stored therein.

### SUMMARY OF THE INVENTION

The foregoing needs are met, to a great extent, by embodiments of the present invention. According to one embodiment of the present invention, a labware storage system is provided. The labware storage system includes a frame that includes a first guidance component positioned substantially parallel to a first edge of the frame. The labware storage system also includes a first storage structure configured to be positioned at a first location within the frame and to hold a first distribution of labware, wherein the first storage structure includes a first alignment component positioned along a first edge of the first storage structure. The labware storage system further includes a second storage structure configured to be positioned at a second location within the frame and to store a second distribution of labware. The second storage structure includes a second alignment component positioned along a first edge of the second storage structure. The labware storage system also includes a labware positioning device configured to position a piece of labware in a storage compartment of at least one of the first storage structure or the second storage structure and to retrieve the piece of labware from the storage component.

According to another embodiment of the present invention, a method of configuring a labware storage system is provided. The method includes introducing a first storage structure, configured to hold a first distribution of labware, into a frame having a labware positioning device located adjacent thereto. The method also includes introducing a second storage structure, configured to hold a second distribution of labware, into the frame. The method further includes positioning the first storage structure and the second storage structure relative to the frame using a first guidance component positioned substantially parallel to a first edge of the frame, a first alignment component positioned on a first edge of the first storage structure and a second alignment component positioned along a first edge of the second storage structure.

According to yet another embodiment of the present invention, another storage system is provided. The storage system includes first storing means for storing a first distribution of labware and second storing means for storing a second distribution of labware. The storage system also includes positioning means for positioning a piece of labware in the first storing means and restricting means, adjacent to the positioning means, for restricting motion of the first storing means and the second storing means relative to the positioning means. The storage system further includes first guiding means, positioned substantially parallel to a first edge of the restricting means, for guiding travel of the first storing means and second storing means relative to the restricting means. In addition, the storage system includes second guiding means, positioned substantially parallel to a first edge of the first storing means, for guiding travel of the first storing means relative to the restricting means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a plurality of different types of labware that may be used according to embodiments of the present invention.

FIG. 2 is a side view of a labware storage system according to an embodiment of the present invention.

FIG. 3 is a perspective view of a labware positioning device according to one embodiment of the present invention.

FIG. 4 is perspective view of a first labware storage hotel and a second labware storage hotel according to embodiments of present invention.

FIG. 5 is a perspective view of the frame illustrated in FIG. 2 and of two labware storage hotels that may be positioned within the frame according to certain embodiments of the present invention.

### DETAILED DESCRIPTION

Certain embodiments of the present invention will now be described with reference to the drawing figures, in which like reference numerals refer to like parts throughout.

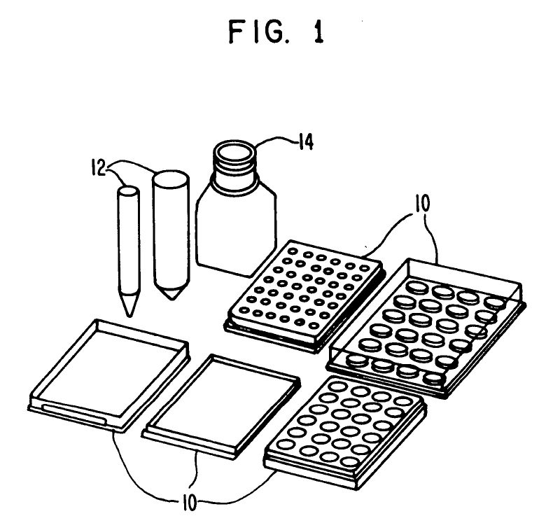

FIG. 1 is a perspective view of a plurality of different types of labware 10, 12, 14 that may be used according to embodiments of the present invention. More specifically, FIG. 1 illustrates five different types of microplates 10 having different geometries and being able to store different numbers of experimental samples. FIG. 1 also illustrates two tubes 12, each having a different geometry, and one bottle 14. In addition to the types of labware illustrated in FIG. 1, other types of labware that may be used according to embodiments of the present invention include vials, deepwell plates, microscope slides, lab-on-a-chip devices, microfluidic devices, nanofluidic device, etc.

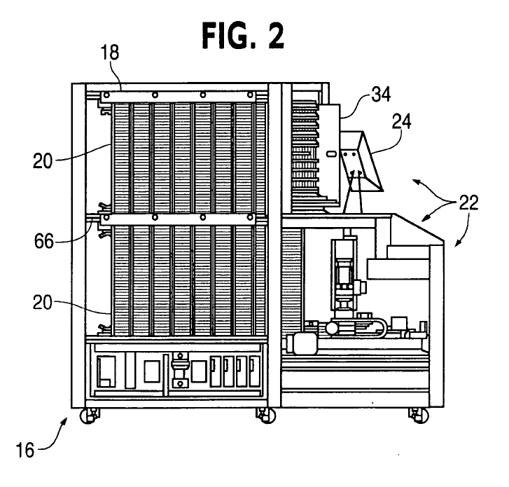

When conducting experiments in a laboratory setting, one or more of the types of labware illustrated in FIG. 1 may be used. Then, depending upon the conditions required to carry out the experimentation procedure, one or more of the types of labware illustrated in FIG. 1 may be stored, either for relatively short or extended periods of time, in enclosures configured to regulate temperature, humidity and/or other environmental conditions. FIG. 2 is a side view of a labware storage system 16 according to an embodiment of the present invention where such environmentally-controlled storage may take place.

The labware storage system 16 illustrated in FIG. 2 includes a frame 18 and a plurality of storage structures 20 that are positioned at a plurality of locations within the frame. Each of the storage structures 20 illustrated in FIG. 2 is configured to hold/store a plurality of pieces of labware.

According to certain embodiments of the present invention, the storage structures 20 illustrated in FIG. 2 are not all configured to store the same distributions of labware. For example, in some labware storage systems 16, one or more of the storage structures 20 are configured to store one type of microplate 10 exclusively while one or more of the other storage structures 20 are configured to hold more than one type of microplate 10 and/or tubes 12 and/or bottles 14. Also, certain storage structures 20 according to the present invention are configured to store one or more of the following types of labware: microplates, tubes, bottles, vials, deepwell plates, microscope slides, lab-on-a-chip devices, microfluidic devices and/or nanofluidic devices.

According to certain embodiments of the present invention, the labware storage system 16 illustrated in FIG. 2 is particularly configured to be used in conjunction with protein crystallization experiments. In such a system 16, the storage structures 20 take the form of hotels and an imager system 22 is included, wherein experimental samples may be imaged and the degree of crystallization in one or more samples may be determined. A controller 24 that controls the operation of the labware storage system is also typically included. More specifically, the controller 24 is often configured to control the environmental conditions within the labware storage system 16 and to control the manner in which labware is introduced into, stored in, and removed from the labware storage system.

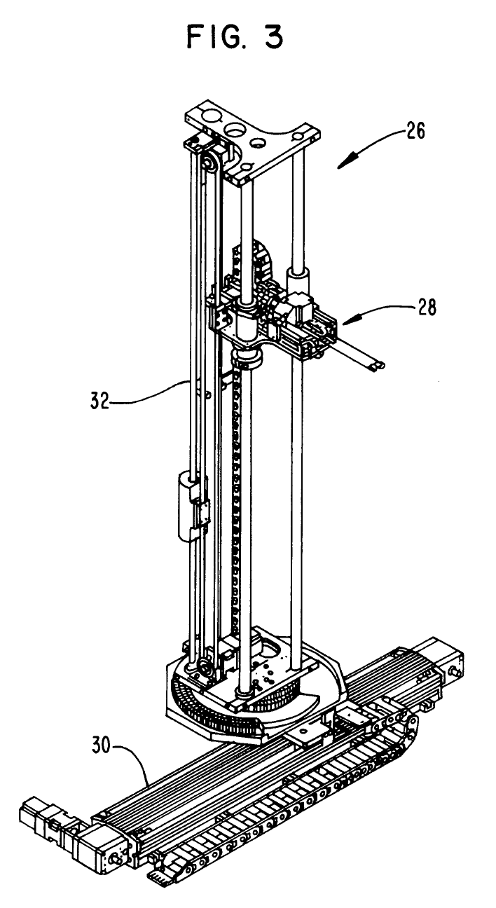

According to certain embodiments of the present invention, the controller 24 controls a labware positioning device 26 such as the one illustrated in FIG. 3. In these embodiments, the labware positioning device 26 is positioned adjacent to the storage structures 20 illustrated in FIG. 2 and the controller 24 controls the position of the labware retrieval component 28 relative to the storage structures 20. More specifically, the controller 24 controls movement of the labware positioning device 26 along the lateral motion component 30, which may take the form of a track that extends alongside the storage structures 20. When removing a piece of labware from a storage structure 10, the controller 24 also controls movement along the height adjusting component 32 to position the labware retrieval component 28 below a piece of stored labware. Then, the controller 24 causes the labware retrieval component 28 to lift the piece of labware and the labware retrieval component 28 retracts away from the storage structure 20. At that point, the controller 24 moves the labware positioning device 26 to an input/output region 34 of the labware storage system 16, where a user may retrieve the piece of labware. In view of the above description, one of skill in the art will appreciate that a reversed process can be used to have the labware positioning device 26 position a piece of labware in a storage compartment or slot of any of the storage structures 20 illustrated in FIG. 2.

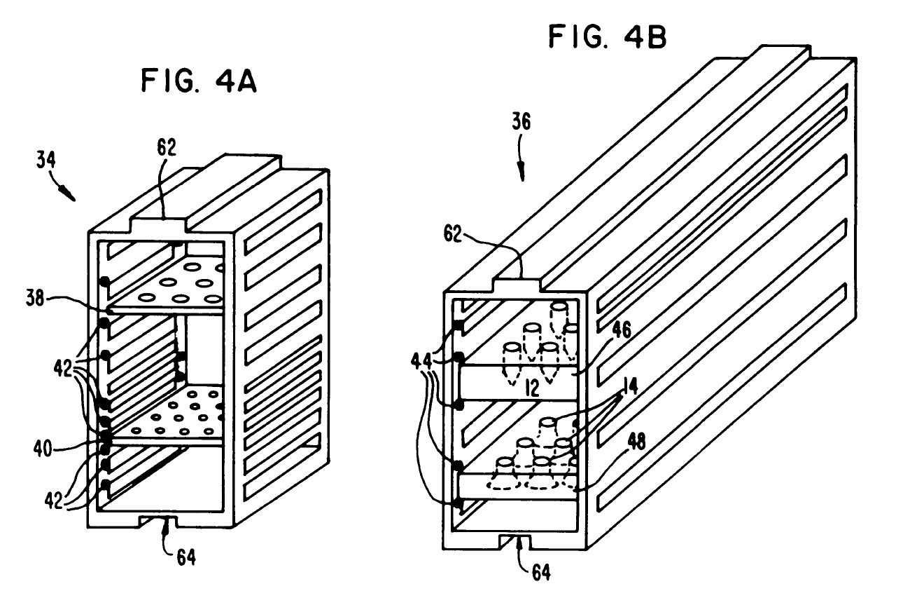

FIG. 4 is a perspective view of a first labware storage hotel 34 and a second labware storage hotel 36 that may be included in the labware storage system 16 illustrated in FIG. 2 according to certain embodiments of the present invention. As illustrated in FIG. 4, the first labware storage hotel 34 and the second labware storage hotel 36 have different dimensions. More particularly, the second labware storage hotel 36 is substantially deeper than the first labware storage hotel 34. However, in certain embodiments of the present invention, both of these hotels 34, 36 may be included in the same labware storage system 16.

As illustrated in FIG. 4, the first labware storge hotel 34 is configured to hold/store a first plate 38 and a second plate 40, each of which is supported on pins 42 that extend into the interior of the first labware storage hotel 34. The first plate 38 is relatively thick compared to the second plate 40 and has fewer, wider indentations for storing samples.

The second labware storage hotel 36 also includes a plurality of pins 44 extend into the interior thereof and that are configured to support a first container 46 and a second container 48. The first container 46, which may take the form of a drawer, has a plurality of tubes 12 included therein and the second container 48 has a plurality of bottles 14 included therein. According to other embodiments of the present invention, labware storage hotels may also be designed to hold/store vials, deepwell plates, microscope slides, lab-on-a-chip devices, micro/nano-fluidic devices and/or other types of labware.

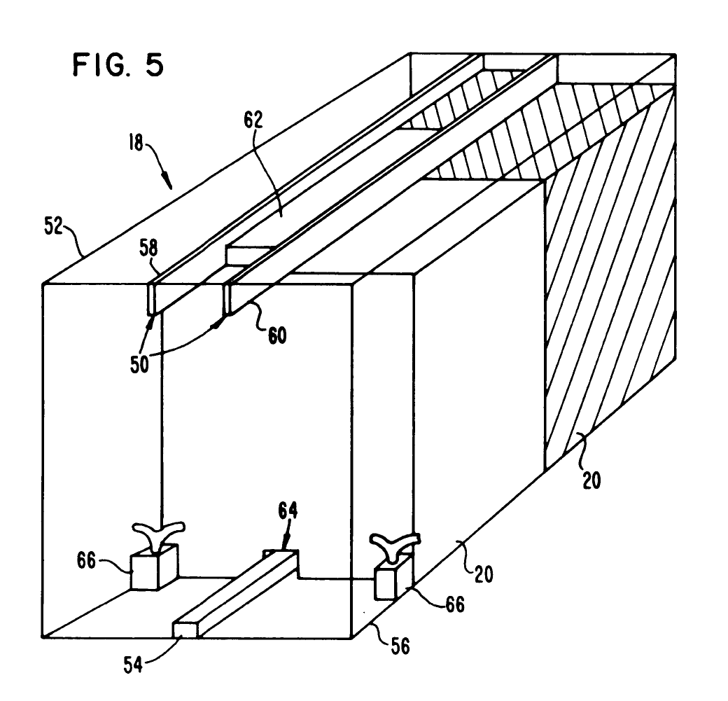

FIG. 5 is a perspective view of the frame 18 illustrated in FIG. 2 and of two labware storage hotels 20 that may be positioned within the frame 18 according to certain embodiments of the present invention. As illustrated in FIG. 5, the frame 18 includes an upper guidance component 50 that is positioned substantially parallel to an upper edge 52 of the frame 18. The frame 18 also includes a lower guidance component 54 that is positioned substantially parallel to a lower edge 56 of the frame.

According to certain embodiments of the present invention, the lower guidance component 54 is made up of a rod, bar or channel that extends in a direction that is substantially parallel to the lower edge 56 of the frame 18. According to certain embodiments of the present invention, the upper guidance component 50 is made up of a first substantially flat plate 58 and a second substantially flat plate 60. The first plate 58 extends in a direction that is substantially parallel to the upper edge 52 of the frame 18 and the second plate 60, which is offset from the first plate 58, extends in a direction that is substantially parallel to the first plate 58.

As illustrated in FIGS. 4 and 5, the labware storage hotels 34, 36 that may be used as the storage structures 20 within the frame 18 in the labware storage system 16 each include an upper alignment component 62 and a lower alignment component 64. When the hotels 34, 36 are positioned within the frame 18, an edge of each hotel 34, 36 is positioned substantially parallel to the upper edge 52 of the frame 18.

As illustrated in FIGS. 4 and 5, the upper alignment component 62 can take the shape of a tab that is configured to be inserted between the first plate 58 and the second plate 60 of the upper guidance component 50. According to certain other embodiments of the present invention, the lower alignment component 64 can take the shape of a slot that is configured to surround a portion of a rod, bar, channel or other structure that typically makes up the lower guidance component 54.

Typically, the storage structures 20 illustrated in FIGS. 2 and 5 are positioned adjacent to each other in the labware storage system 16 illustrated in FIG. 2. Each of the storage structures 20 are then secured at particular positions within the frame 18 in the labware storage system 16 by one of more securing mechanisms 66. According to certain embodiment of the present invention, the securing mechanisms 66 take the form of clamps that are secured to either a portion of the frame 18 or to some other fixed portion of the labware storage system 16. However, other methods of securing the positions of the storage structures 20 are also within the scope of the present invention. For example, screws or bolts may be used.

According to certain embodiments of the present invention, a method of configuring a labware storage system is provided. According to this method, a first storage structure is introduced into a frame having a labware positioning device located adjacent thereto. Typically, the first storage structure is configured to hold a first distribution of the labware. Also according to this method, a second storage structure is also introduced into the frame and the second storage structure is configured to hold a second distribution of labware. In many instances, the first distribution of labware and the second distribution of labware are not equivalent. However, when implementing the above method using the labware storage system 16, two or more of the storage structures 20 illustrated in FIG. 1 may have equivalent distributions of labware.

According to certain embodiments of the above-discussed method, the step of introducing the first storage structure includes selecting the first storage structure to be configured to hold/store at least two items selected from the following list: a first type of microplate, a second type of microplate, a tube, a bottle, a vial, a deepwell plate, a microscope slide, a lab-on-a-chip device, a microfluidic device and a nanofluidic device. Any ratio of the at least two items may be selected. For example, the first storage structure may be configured to hold/store vials in 50% of its storage compartments or slots and to hold/store microplates in the remaining 50% of its storage compartments or slots, or the ratio may be 75% to 25%, 90% to 10%, etc.

The above-described method may also include selecting the second storage structure to have a geometry that is different from the geometry of the first storage structure. For example, the second storage structure may be deeper than the first storage structure.

The method may also includes positioning the first storage structure and the second storage structure relative to the frame using a first guidance component that is positioned substantially parallel to a first edge of the frame. A first alignment component positioned along a first edge of the first storage structure and a second alignment component positioned along a first edge of the second storage structure may also be used.

According to the method, the first storage structure and the second storage structure may also be positioned relative to the frame using a second guidance component that is positioned substantially parallel to a second edge of the frame. Further, the first storage structure and/or the second storage structure may be positioned relative to the frame using a third alignment component that is positioned along a second edge of the first storage structure. Then, the first storage structure is typically secured at a first location within the frame and the second storage structure is typically secured at a second location within the frame that is adjacent to the first location.

Often, the first guidance component is selected to include a rod or square channel and the first alignment component is selected to include a slot that is configured to surround a portion of the rod or channel. Also, the first storage structure and the second storage structure may be positioned relative to the frame using a pair of substantially parallel plates that are positioned substantially parallel to a second edge of the frame and a tab configured.to be inserted between the pair of substantially parallel plates. Typically, the tab is included as part of the first storage structure and/or the second storage structure.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A labware storage system, comprising:
a frame that includes a first guidance component positioned substantially parallel to a first edge of the frame;
a first storage structure configured to be positioned at a first location within the frame and to hold a first distribution of labware, wherein the first storage structure includes a first alignment component positioned along a first edge of the first storage structure;
a second storage structure configured to be positioned at a second location within the frame and to store a second distribution of labware, wherein the second storage structure includes a second alignment component positioned along a first edge of the second storage structure; and
a labware positioning device configured to position a piece of labware in a storage compartment of at least one of the first storage structure or the second storage structure and to retrieve the piece of labware from the storage compartment.

2. The labware storage system of claim 1, wherein the frame comprises:
a second guidance component positioned substantially parallel to a second edge of the frame.

3. The labware storage system of claim 2, wherein the first storage structure comprises:
a third alignment component positioned along a second edge of the first storage structure.

4. The labware storage system of claim 3, wherein the second guidance component comprises a first plate and a second plate positioned substantially parallel to the first plate and wherein the second alignment component comprises a tab configured to be inserted between the first plate and the second plate.

5. The labware storage system of claim 1, further comprising:
a securing mechanism configured to secure the first storage structure at the first location within the frame.

6. The labware storage system of claim 1, wherein the first distribution of labware includes at least two of a first type of microplate, a second type of microplate, a tube, a bottle, a vial, a deepwell plate, a microscope slide, a lab-on-a-chip device, a microfulidic device and a nanofluidic device.

7. The labware storage system of claim 6, wherein the first storage structure and the second storage structure have different geometries.

8. The labware storage system of claim 1, wherein the first guidance component comprises at least one of a rod, a bar or a channel and wherein the first alignment component comprises a slot configured to surround a portion of the first guidance component.

9. The labware storage system of claim 1, wherein the first storage structure and the second storage structure are adjacent to each other.

10. A method of configuring a labware storing system, the method comprising:
introducing a first storage structure, configured to hold a first distribution of labware, into a frame having a labware positioning device located adjacent thereto;
introducing a second storage structure, configured to hold a second distribution of labware, into the frame; and
positioning the first storage structure and the second storage structure relative to the frame using a first guidance component positioned substantially parallel to a first edge of the frame, a first alignment component positioned along a first edge of the first storage structure and a second alignment component positioned along a first edge of the second storage structure.

11. The method of claim 10, further comprising:
positioning the first storage structure and the second storage structure relative to the frame using a second guidance component positioned substantially parallel to a second edge of the frame.

12. The method of claim 10, further comprising:
positioning the first storage structure relative to the frame using a third alignment component positioned along a second edge of the first storage structure.

13. The method of claim 10, further comprising:
securing the first storage structure at a first location within the frame.

14. The method of claim 13, further comprising:
securing the second storage structure at a second location within the frame that is adjacent to the first location.

15. The method of claim 10, wherein the introducing the first storage structure step comprises selecting the first storage structure to hold at least two of a first type of microplate, a second type of microplate, a tube, a bottle, a vial, a deepwell plate, a microscope slide, a lab-on-a-chip device, a microfulidic device and a nanofluidic device.

16. The method of claim 10, wherein the introducing the second storage structure step comprises selecting the second storage structure having a geometry that is different from the first storage structure.

17. The method of claim 10, wherein the positioning step comprises:
selecting the first guidance component to include at least one of a rod, a bar or a channel; and
selecting the first alignment component to include a slot configured to surround a portion of the first guidance component.

18. The method of claim 10, further comprising:
positioning the first storage structure and the second storage structure relative to the frame using a pair of substantially parallel plates positioned substantially parallel to a second edge of the frame and a tab configured to be inserted between the pair of substantially parallel plates.

19. A storage system, comprising:
first storing means for storing a first distribution of labware;
second storing means for storing a second distribution of labware;
positioning means for positioning a piece of hardware in the first storing means;
restricting means, adjacent to the positioning means, for restricting motion of the first storing means and second storing means relative to the positioning means;
first guiding means, positioned substantially parallel to.a first edge of the restricting means, for guiding travel of the first storing means and second storing means relative to the restricting means; and
second guiding means, positioned substantially parallel to a first edge of the first storing means, for guiding travel of the first storing means relative to the restricting means.

20. The storage system of claim 19, wherein the first storing means is configured to store at least two of a first type of microplate, a second type of microplate, a tube, a bottle, a vial, a deepwell plate, a microscope slide, a lab-on-a-chip device, a microfulidic device and a nanofluidic device
